(19) United States
(12) Patent Application Publication
(10) Pub. No.: US 2023/0381927 A1
(43) Pub. Date: Nov. 30, 2023

(54) COMBINATION ELECTRICIANS TOOL

(71) Applicant: THOMAS GUDGEON, SANTA YNEZ, CA (US)

(72) Inventor: THOMAS GUDGEON, SANTA YNEZ, CA (US)

(21) Appl. No.: 18/203,061

(22) Filed: May 30, 2023

Related U.S. Application Data
(60) Provisional application No. 63/347,394, filed on May 31, 2022.

(51) Int. Cl. B25B 7/22; B25B 23/16

(52) U.S. Cl. CPC B25B 7/22; B25B 23/16

(57) ABSTRACT

A tool having first and second elongated arms, each arm having first and second axial extremities and a fulcrum pivotally joining the first and second arms intermediate the respective first and second axial extremities of the first and second elongated arms. The first axial extremities of the first and second arms having elongated compressive grip surfaces. The second axial extremities have facing jaw surfaces, the facing jaw surfaces distal to the fulcrum being diagonal cutter surfaces and the facing jaw surfaces further including linesman plier jaw surfaces intermediate the fulcrum and the diagonal cutter surfaces.

### CROSS-REFERENCE TO RELATED APPLICATIONS

This application claims the priority of U.S. provisional application 63/347,394 filed 2022 May 31 by the same inventor.

### TECHNICAL FIELD

The present invention is generally directed to tools. More particularly, the present invention is directed to hand tools. Even more particularly, the present invention is directed to tools used by electricians as well as other artisans.

### BACKGROUND OF THE INVENTION

When at a worksite, electricians may need several hand tools to complete different tasks. Among the several tasks that an electrician might need to perform at a worksite include cutting wire and sheathing. Moreover, the different individual tools used by the electricians can be used to cut metallic flexible conduit, twist several wires together, strip nonmetallic sheathing, strip wire, and cut large wire. Unfortunately, these different tasks cannot all be performed by a single tool. That requires that the electrician have access to multiple tools at a worksite.

When an electrician goes to a work site, he or she must transport all the necessary tools that could be required. Access to the required tools is always a material consideration. Access is in some cases aggravated by scaffolding, a ladder, or a cherry picker. Having to transport all required tools can be cumbersome for electricians. Additionally, having to switch tools when having to accomplish different tasks can be time-consuming. Especially, if the electrician needs to search for the necessary tool to perform the required task. In order to address these concerns, the present invention provides users with a multifunctional tool for cutting conduit, twisting wires, stripping sheathing, stripping wire, cutting wire, and more.

The prior art includes linesman pliers. As shown in FIG. 1 linesman pliers 10 are distinguished by opposed generally planar gripping surfaces 12 that are often adjacent to a snub nose 14. The substantially planar gripping surfaces may include a plurality of parallel inverted V-shaped ridges 11 as best seen in FIG. 6. The term “linesman jaws” as used herein will be understood to refer to the substantially planar gripping surfaces shown in FIGS. 1 and 6.

The generally planar contour of the jaws of linesman pliers is particularly useful for creating accurate right-angle bends. As used herein the term “generally planar” includes jaw faces that are precisely planar as well as faces having, for example, teeth 13 or cross-hatched knurling on the surface thereof to better engage, for example, multiple wires. The size, construction and durability of these pliers allow them to be used for tasks like removing nails and other types of fasteners.

Adjacent to the surfaces 12 are respective concave/curved gripping surfaces 16 which is useful in light engineering to work with metal bar, etc. Opposed beveled cutting edges 18 are proximate to a pivot 20. The pivot 20 couples compressive grip surfaces 22 and 24.

Designed for potentially heavy manual operation, these pliers typically are machined from forged steel and the two handles are precisely joined with a heavy-duty pivot 20 that maintains the pliers' accuracy even after repeated use under extreme force on a heavy-gauge wire. They usually have grips for better handling than bare metal handles; the grips may also provide insulation for protection against electric shock when working with live circuits.

Lineman's pliers are used in the electrical trade to cut, straighten, and bend wire, and also to twist wires together when making splices. Lineman pliers can be used to strip wire and some types of cable, although wire strippers are more commonly used for this purpose as they can strip wire more quickly without damaging the conductors themselves. They can also be used to pull a fish tape through long runs of conduit where the high friction makes it difficult to pull the tape by hand.

Lineman's pliers can also be used to bend or straighten sheet metal components, especially in cases where smaller pliers don't offer enough mechanical advantage.

The prior art also includes diagonal cutters 30 as shown in FIGS. 2 and 3 (also known as wire cutters, diagonal cutting pliers, diagonal cutters, side cutters, dikes, or Nippy cutters) are pliers intended for the cutting of wire (they are generally not used to grab or turn anything). The plane defined by the cutting edges 32 of the jaws 34 intersects the joint rivet or pivot 36 at an angle or “on a diagonal”, hence the name. The term “diagonal cutter jaws” as used herein will be understood to mean the jaws 34 with cutting edges 32 as illustrated in FIGS. 2 and 3.

It is inherent in the prior art apparatus that the cutting edges 18 of the linesman pliers 10 extend very close to the heavy-duty pivot 20. Similarly, the cutting edges 32 of the diagonal cutters 30 extend close to the joint rivet or pivot 36. This structure is clearly indicative of a precognitive that the maximum mechanical advantage is achieved by a cutting edge close to one side of a pivot combined with compressive grip surfaces extending much further from the opposite side of the pivot.

The rationale of constructing cutting edges to extend very close to the cutting tool pivot inherently motivates the use of multiple tools to accomplish many common tasks. An additional motivation for separate tools is the need to isolate the gripping and cutting functions. Accordingly, it is therefore seen that there exists a need in the art to reconsider the deficiencies and limitations described herein and above.

### SUMMARY OF THE INVENTION

The shortcomings of the prior art are overcome and additional advantages are provided through a tool having first and second elongated arms, each arm having first and second axial extremities and a fulcrum pivotally joining the first and second arms intermediate the respective first and second axial extremities of the first and second elongated arms. The first axial extremities of the first and second arms have elongated compressive grip surfaces.

The second axial extremities have facing jaw surfaces, the facing jaw surfaces distal to the fulcrum being diagonal cutter surfaces and the facing jaw surfaces further including linesman plier jaw surfaces intermediate the fulcrum and the diagonal cutter surfaces.

In some embodiments, the tool further includes facing surfaces for shear cutting intermediate the lineman's plier surfaces and the fulcrum. Still other embodiments may include other facing jaw surfaces intermediate the linesman plier surfaces and the fulcrum. Thus, the tool in accordance with the present invention can cut wire, flex, copper, and steel unlike other tools

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. Although specific features of various exemplary embodiments of the invention may be shown in some drawings and not in others, this is for convenience only. In accordance with the principles of the invention, any feature of a drawing maybe referenced and/or claimed in combination with any feature of any other drawing.

The invention, however, both as to organization and method of practice, together with the further objects and advantages thereof, may best be understood by reference to the following description taken in connection with the accompanying drawings in which:

FIG. 1 is a front view of a prior art linesman pliers,

FIG. 2, is a front view of a prior art diagonal cutter.

FIG. 3 is a side view of the same prior art diagonal cutter,

FIG. 4 is a front view of an embodiment of the combination electricians tool in accordance with the present invention.

FIG. 5 is a partially schematic fragmentary side view of the embodiment of the combination electricians tool shown in FIG. 4.

FIG. 6 is a close-up view of the inverted V-shape surface of the substantially planar surface of a linesman plier.

### DETAILED DESCRIPTION

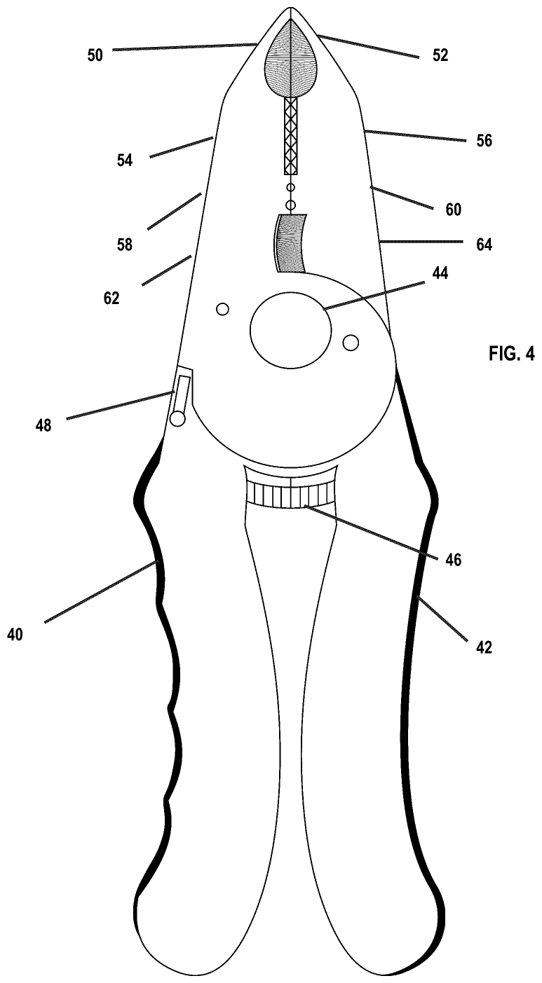

Referring now to FIG. 4 there is shown a combination electricians tool in accordance with one form of the present invention. The tool includes a pair of arms 40, 42 each including a compressive grip surface disposed on the lower (as viewed) end and a jaw disposed on the upper (as viewed) end, wherein the arms are pivotally connected to one another with a pivot pin or fulcrum 44. A spring 46 biases the jaws to an open position. The compressive grip surface on the arm 40 is characterized by four arcuate recesses dimensioned for the accommodation of the user's fingers. The compressive grip surface on the arm 42 is a single curvilinear recess for accommodating the palm of the user's hand. Thus, the compressive grip surfaces collectively facilitate the user applying greater force to the compressive grip surfaces.

A pivoting locking tab 48 is configured to selectively lock the assembly in a closed position. The jaws on each arm 40, 42 have a plurality of facing elements sequentially disposed between the upper as viewed extremity of each arm and the fulcrum 44.

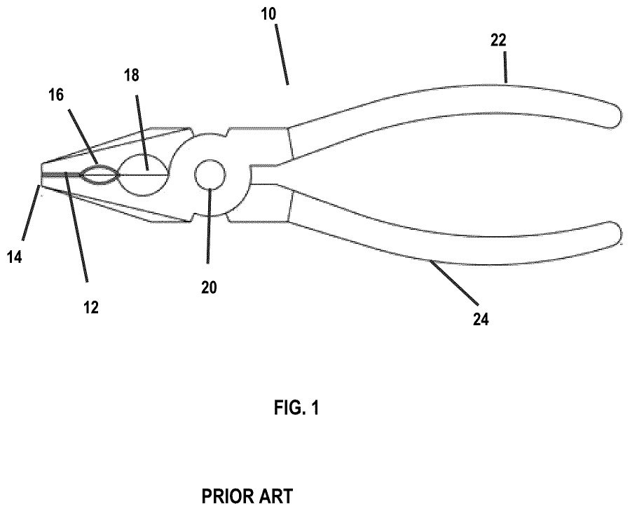

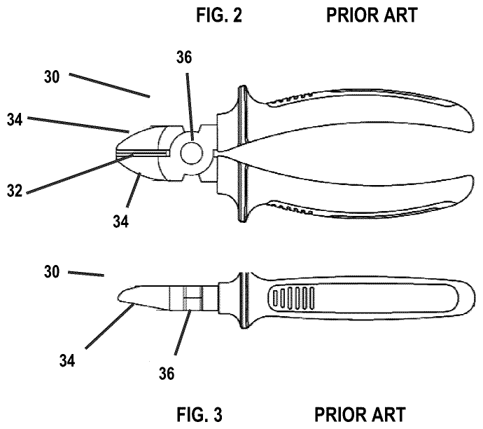

More specifically, at the extremity of the arms 40, 42 most distal from the fulcrum 44 are respective diagonal cutter portions 50, 52 having a construction such as that shown in FIGS. 2 and 3. The arms 40, 42 further include respective axially adjacent sections 54, 56 having a construction corresponding to the linesman jaws 12 illustrated in FIG. 1.

The arms 40, 42 further include respective sections 58, 60 that collectively provide a wire stripping capability. In addition, respective opposed sections 62, 64 collectively provide a shear cutting capability. Those skilled in the art will recognize that the shear cutting is achieved in the same manner as conventional scissors.

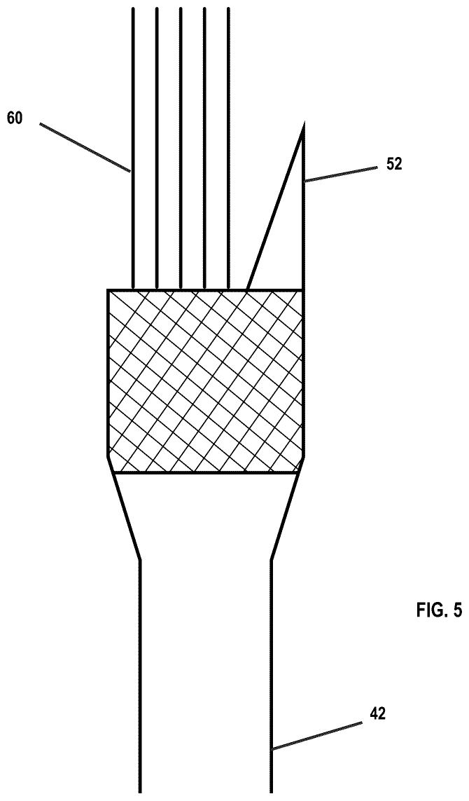

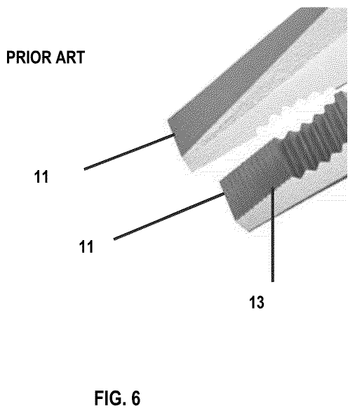

FIG. 5 is a partially schematic fragmentary side view of the embodiment of the combination electricians tool shown in FIG. 4. This view illustrates, for example, five wires 60 can engage the lineman jaws 12 despite the location of the diagonal cutter 52 outboard of the linesman jaws 12.

Accordingly, the tool provides the capability of both a diagonal cutter and linesman pliers in a single product. This is achieved despite (1) the conventional rationale of constructing cutting edges to extend very close to the cutting tool pivot inherently motivates the use of multiple tools to accomplish many common tasks and (2) need to isolate the gripping and cutting functions. Accordingly, it is therefore seen that there exists a need in the art to overcome the deficiencies and limitations described herein and above.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

It will be understood that, in general, terms used herein, and especially in the appended claims, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “an image” should typically be interpreted to mean “at least one image”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “two images,” or “a plurality of images,” without other modifiers, typically means at least two images). Furthermore, in those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

While the invention has been described in terms of various specific embodiments, those skilled in the art will recognize that the invention can be practiced with modification within the spirit and scope of the claims. While certain embodiments of the invention have been illustrated and described, various modifications are contemplated and can be made without departing from the spirit and scope of the invention. Accordingly, it is intended that the invention is not to be limited, except as by the appended claim(s).

The teachings disclosed herein may be applied to other systems and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the present invention with which that terminology is associated. In general, the terms used in the following claims should not be constructed to limit the present invention to the specific embodiments disclosed in the specification unless the above description section explicitly define such terms. Accordingly, the actual scope encompasses not only the disclosed embodiments, but also all equivalent ways of practicing or implementing the disclosed present invention. The above description of embodiments of the present invention is not intended to be exhaustive or limited to the precise form disclosed above or to a particular field of usage.

While certain aspects of the present invention are presented below in particular claim forms, various aspects of the present invention are contemplated in any number of claim forms. Thus, the inventor reserves the right to add additional claims after filing the application to pursue such additional claim forms for other aspects of the present invention.

What is claimed is:

1. A tool having first and second elongated arms, each arm having first and second axial extremities;
a fulcrum pivotally joining said first and second arms intermediate the respective first and second axial extremities of said first and second elongated arms;
said first axial extremities of said first and second arms having elongated compressive grip surfaces;
said second axial extremities having facing jaw surfaces, said facing jaw surfaces distal to said fulcrum being diagonal cutter surfaces; and
said facing jaw surfaces further including linesman pliers jaw surfaces intermediate said fulcrum and said diagonal cutter surfaces.

2. A tool as described in claim 1 further including facing surfaces for shear cutting intermediate said linesman plier surfaces and said fulcrum.

3. A tool as described in claim 1 wherein one of said compressive grip surfaces includes four arcuate recesses dimensioned for the accommodation of a user's fingers.

4. A tool as described in claim 1 wherein one of said compressive grip surfaces includes a single curvilinear recess for accommodating the palm of a user's hand.
